(19) United States
(12) Patent Application Publication
(10) Pub. No.: US 2019/0306337 A1
(43) Pub. Date: Oct. 3, 2019

(54) COMMUNICATION APPARATUS, CONTROL METHOD, AND STORAGE MEDIUM

(71) Applicant: CANON KABUSHIKI KAISHA, Tokyo (JP)

(72) Inventor: Wataru Tachiwa, Yokohama-shi (JP)

(21) Appl. No.: 16/362,484

(22) Filed: Mar. 22, 2019

(30) Foreign Application Priority Data
Mar. 30, 2018 (JP) 2018-066931

(51) Int. Cl. H04N 1/00; H04W 4/23; H04W 4/80; H04W 52/02; H04W 84/12

(52) U.S. Cl. CPC H04N 1/00315; H04N 1/00771; H04W 4/23; H04W 84/12; H04W 52/0235; H04W 52/0222; H04W 4/80

(57) ABSTRACT

A communication apparatus changes information to be included in an advertising packet based on reception of a predetermined signal conforming to Bluetooth® Low Energy standard from another communication apparatus.

### BACKGROUND

### Field

The present disclosure relates to an apparatus that transmits an advertisement.

### Description of the Related Art

In recent years, the Bluetooth® Low Energy standard that is a wireless standard with low power consumption was established. According to the Bluetooth® Low Energy standard, a communication apparatus can provide various kinds of information to another communication apparatus by repeatedly transmitting an advertising packet.

In the Bluetooth® Low Energy standard, an upper limit size of data (information) to be included in the advertising packet is determined, and data having a size exceeding the upper limit cannot be included in one advertising packet. Accordingly, as a method of providing data (information) having a size exceeding the upper limit to another communication apparatus, United States Patent Application Publication No. 2016/0366715 discusses that data to be included in the advertising packet is changed every predetermined time.

However, if there is no apparatus that receives the data (information) around the communication apparatus, changing of the data to be included in the advertising packet every predetermined time is inefficient.

### SUMMARY

According to an aspect of the present disclosure, a communication apparatus includes a transmission unit configured to transmit an advertising packet conforming to the Bluetooth® Low Energy standard, a reception unit configured to receive a predetermined signal conforming to the Bluetooth® Low Energy standard from another communication apparatus, and a control unit configured to, based on receipt of the predetermined signal, control the transmission unit to transmit the advertising packet including information different from information before the predetermined signal is received.

Further features will become apparent from the following description of exemplary embodiments with reference to the attached drawings.

### BRIEF DESCRIPTION OF THE DRAWINGS

FIG. 1 is a block diagram illustrating a communication system according to a first exemplary embodiment.

FIG. 2 is a block diagram illustrating a hardware configuration of an image forming apparatus.

FIG. 3 is a flowchart illustrating a flow of processing performed by a control unit.

FIG. 4 is a flowchart illustrating a flow of processing to transmit an advertising packet.

FIG. 5 is a diagram illustrating contents in the advertising packet.

FIG. 6 is a sequence diagram illustrating a flow of communication in the communication system.

FIG. 7 is a flowchart illustrating a flow of processing performed by a control unit according to a second exemplary embodiment.

### DESCRIPTION OF THE EMBODIMENTS

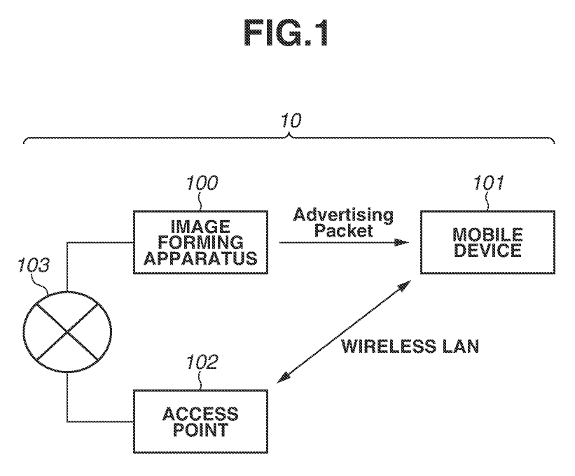

FIG. 1 illustrates a configuration of a communication system 10 according to a first exemplary embodiment. The communication system 10 is a communication system to print, by an image forming apparatus 100, a document and an image held by a mobile device 101. Examples of the mobile device 101 include a smartphone, a mobile telephone, a laptop personal computer (PC), a tablet PC, and any other communication apparatuses. Further, the image forming apparatus 100 may be a multifunction printer (MFP) or a single function printer (SFP). Further, in place of the image forming apparatus 100, and any other communication apparatuses such as a headset, a speaker, a projector, and a camera may be used.

The mobile device 101 establishes connection for print data transmission with the image forming apparatus 100 through an access point 102 of a wireless local area network (LAN) conforming to Institute of Electrical and Electronics Engineers (IEEE) 802.11 series and a LAN 103. The image forming apparatus 100 performs printing of the print data acquired from the mobile device 101 through the connection. As a protocol for print data transmission according to the present exemplary embodiment, internet protocol (IP) is used; however, the protocol for print data transmission is not limited thereto.

The mobile device 101 or the image forming apparatus 100 may include a function of the access point 102, and the mobile device 101 and the image forming apparatus 100 may directly establish the connection for print data transmission. In addition, in place of the LAN 103, a wide area network (WAN) may be used. Further, in place of the wireless LAN, a public wireless network such as long term evolution (LTE) may be used. In this case, the access point 102 can be replaced with a base station of the public wireless network. Further, in place of the wireless LAN, the Bluetooth® standard may be used.

The image forming apparatus 100 intermittently repeatedly transmits an advertising packet conforming to the Bluetooth® Low Energy standard. The advertising packet includes information (data) relating to the image forming apparatus 100. The information relating to the image forming apparatus 100 includes information relating to services provided by the image forming apparatus 100 (e.g., service identification (ID) representing that image forming apparatus 100 provides a printing service), and a network identifier to establish connection with the image forming apparatus 100. The network identifier to establish the connection with the image forming apparatus 100 is, for example, a service set identifier (SSID) of the wireless network provided by the access point 102. In a case where the image forming apparatus 100 includes the function of the access point 102, the network identifier may be an SSID of a wireless network provided by the image forming apparatus 100.

Further, the information relating to the image forming apparatus 100 may include identification information to distinguish the image forming apparatus 100 from the other apparatuses, for example, a unique ID such as a name and an IP address. In addition, the information relating to the image forming apparatus 100 may include a remaining amounts of sheets, ink, or toner held by the image forming apparatus 100, and/or information notifying shortage thereof, and information on the number of print jobs in queue of the image forming apparatus 100.

The mobile device 101 receives an advertising packet from the image forming apparatus 100, establishes connection for print data transmission with the image forming apparatus 100 using information relating to the image forming apparatus 100 included in the packet, and transmits print data. The mobile device 101 may display the name, the residual amount of sheets, and other information of the image forming apparatus 100, and may allow a user to select whether to perform printing through the connection with the image forming apparatus 100.

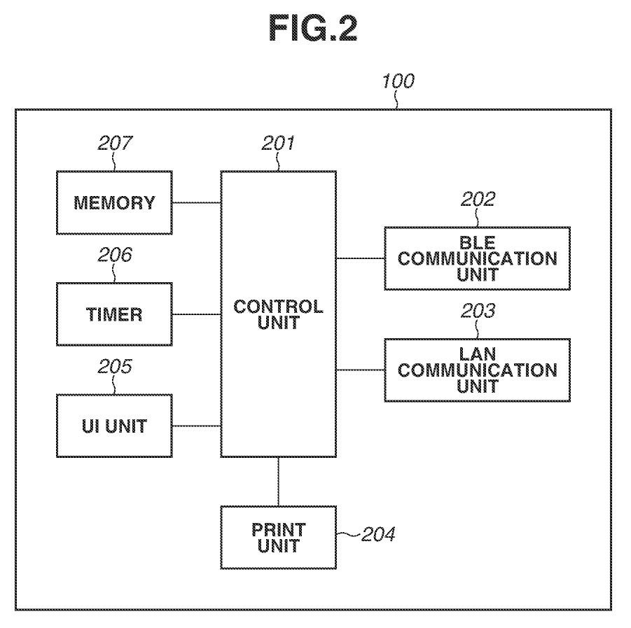

FIG. 2 illustrates a hardware configuration of the image forming apparatus 100. The image forming apparatus 100 includes a control unit 201, a Bluetooth® Low Energy communication (BLE) unit 202, a LAN communication unit 203, a print unit 204, a user interface (UI) unit 205, a timer 206, and a memory 207.

The control unit 201 executes a control program stored in the memory 207, thereby controlling the image forming apparatus 100. The control unit 201 includes one or more processors such as a central processing unit (CPU) or a micro processing unit (MPU), and executes a computer program stored in the memory 207, thereby controlling the image forming apparatus 100. The control unit 201 may control the image forming apparatus 100 by cooperating with a program and an operating system (OS) stored in the memory 207. The control unit 201 uses the memory 207 to store values of variables during execution of the control program. Further, the control unit 201 uses a timer 206 to measure a time.

The BLE communication unit 202 transmits and receives a Bluetooth® Low Energy wireless packet to and from the mobile device 101 through a communication system conforming to the Bluetooth® Low Energy standard under the control of the control unit 201. The BLE communication unit 202 includes components and functions, necessary to perform communication conforming to the Bluetooth® Low Energy standard, such as an antenna, a modulation/demodulation circuit, and a processor performing media access control. The BLE communication unit 202 includes a function as a controller subsystem specified by the Bluetooth® Low Energy standard, and communicates with the control unit 201 based on a host controller interface (HCI) message specification conforming to the Bluetooth® Low Energy standard. The BLE communication unit 202 may have a configuration other than Bluetooth® controller subsystem. When the contents of the advertising packet are set by the control unit 201 through the HCI, the BLE communication unit 202 thereafter repeatedly transmits the advertising packet including identical information autonomously.

The LAN communication unit 203 includes components and functions, such as a modulation/demodulation circuit, and a processor performing media access control, necessary to communicate with other devices through Ethernet® specified by IEEE 802.3 series and IP communication. The LAN communication unit 203 establishes connection for print data transmission with the mobile device 101, and receives print data, under the control of the control unit 201. The LAN communication unit 203 may include a function necessary for the wireless LAN communication, and may establish the connection for print data transmission with the mobile device 101 through the wireless LAN. In this case, the BLE communication unit 202 and the LAN communication unit 203 may be incorporated in the same chip.

The print unit 204 has a function to print an image and a character on a sheet under the control of the control unit 201. The UI unit 205 has a function to perform acquisition of user operation and presentation to the user. For example, the UI unit 205 is a keyboard and a display, or a touch panel.

The memory 207 includes one or more memories such as a read-only memory (ROM) and a random access memory (RAM), and stores various kinds of information such as a computer program to perform various kinds of operations described below. As the memory 207, a storage medium such as a flexible disc, a hard disk, an optical disc, a magnetooptical disk, a compact disc read only memory (CD-ROM), a compact disc recordable (CD-R), a magnetic tape, a nonvolatile memory card, and a digital versatile disc (DVD) may be used in addition to the memory such as a ROM and a RAM.

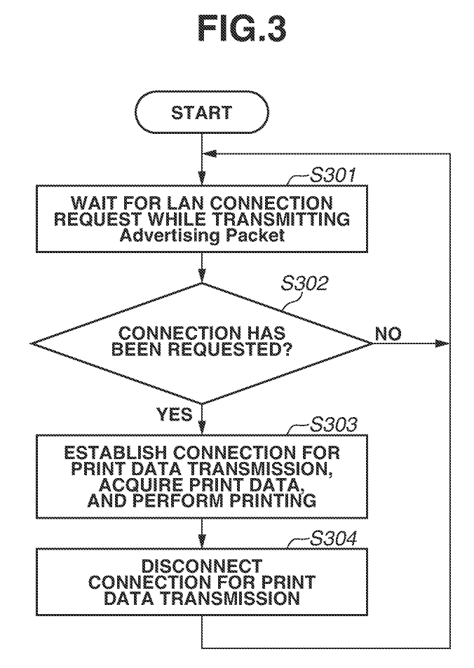

FIG. 3 illustrates a flow of processing by the control unit 201. The processing in the flowchart illustrated in FIG. 3 is started when the image forming apparatus 100 is turned on. Alternatively, the processing in the flowchart illustrated in FIG. 3 may be started when the Bluetooth® Low Energy communication of the image forming apparatus 100 is activated. The image forming apparatus 100 is turned on and the Bluetooth® Low Energy communication is activated, for example, in response to a user instruction provided through the UI unit 205, in a case where a time counted by the timer 206 reaches a predetermined time, or in response to an instruction from the mobile device 101 or a not illustrated external apparatus.

The processing in the flowchart illustrated in FIG. 3 is achieved when the control unit 201 reads and executes a program stored in the memory 207. A part or all of steps in the flowchart illustrated in FIG. 3 may be achieved by hardware such as an application specific integrated circuit (ASIC).

First, in step S301, the control unit 201 controls the BLE communication unit 202 to transmit an advertising packet including the information relating to the image forming apparatus 100. Then, in step S301, the control unit 201 waits for connection request for print data transmission from the mobile device 101 through the LAN communication unit 203. Further, the control unit 201 repeats the operation in step S301 until the control unit 201 receives the connection request (NO in step S302).

In a case where the control unit 201 receives the connection request (YES in step S302), the processing proceeds to step S303. In step S303, the control unit 201 establishes the connection for print data transmission with the mobile device 101 through the LAN communication unit 203, acquires print data from the mobile device 101, and performs printing. In step S304, when the printing is finished, the control unit 201 disconnects the connection for print data transmission. Thereafter, the processing returns to step S301.

In a case where the image forming apparatus 100 is turned off or in a case where the Bluetooth® Low Energy communication of the image forming apparatus 100 is deactivated, the processing in the flowchart illustrated in FIG. 3 ends. The image forming apparatus 100 is turned off and the Bluetooth® Low Energy communication is invalidated, for example, in response to a user instruction provided through the UI unit 205, in a case where a time counted by the timer 206 reaches a predetermined time, or in response to an instruction from the mobile device 101 or a not illustrated external apparatus. In addition, the processing in the flowchart illustrated in FIG. 3 may end based on disconnection of print data transmission.

In the above-described flowchart, in the case where the connection request for print data transmission is received, the processing in step S301, i.e., transmission of the advertising packet is stopped until the connection for print data transmission established in response to the request is disconnected. Alternatively, the control unit 201 may continue the processing in step S301 in parallel while executing the processing in steps S303 and S304. This makes it possible to provide the information relating to the image forming apparatus 100 to another communication apparatus even during execution of the print processing.

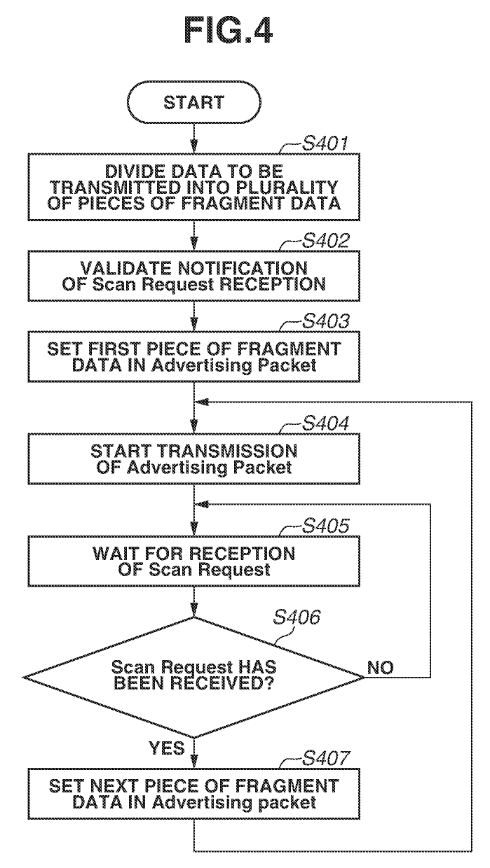

Next, processing to transmit the advertising packet is described with reference to FIG. 4. The processing in the flowchart illustrated in FIG. 4 is started at the same time when the processing in the flowchart illustrated in FIG. 3 is started, and is executed in parallel with the processing in steps S301 and S302. In addition, the processing in the flowchart illustrated in FIG. 4 is interrupted while the processing in steps S301 and S302 is not executed. The control unit 201 resumes the processing in the flowchart illustrated in FIG. 4 from the interrupted step at a timing when the processing in steps S301 and S302 is resumed. In a case where the processing in the flowchart illustrated in FIG. 3 ends, the processing in the flowchart illustrated in FIG. 4 also ends.

First, in step S401, the control unit 201 divides the information relating to the image forming apparatus 100 into a plurality of pieces of fragment data. Information to connect the pieces of fragment data to restore the information before division is added to each of the pieces of fragment data. For example, information representing the total number of pieces of fragment data and information representing the order of each of the pieces of fragment data are added. Each of the pieces of fragment data has a size includable in one advertising packet (size not exceeding upper limit specified by the Bluetooth® Low Energy standard).

Next, in step S402, the control unit 201 controls the BLE communication unit 202 to perform setting in such a manner that, in a case where a predetermined signal conforming to the Bluetooth® Low Energy standard is received from another device, the BLE communication unit 202 notifies the control unit 201 of signal reception. In this example, the setting is made so that the BLE communication unit 202 performs notification to the control unit 201 in a case where a scan request conforming to the Bluetooth® Low Energy standard is received as the predetermined signal. The scan request is a packet specified by the Bluetooth® Low Energy standard, and is transmitted, from the other device that has received the advertising packet, in order to request additional information. In other words, when the image forming apparatus 100 receives the scan request, the image forming apparatus 100 transmits the additional information to the other device.

In addition, the setting is made when the control unit 201 transmits, to the BLE communication unit 202, Scan_Request_Notification_Enable parameter of the HCI message as 1 (valid). Examples of the HCI message include HCI_LE_Set_Extended_Advertising_Parameters message. A transmission cycle of the advertising packet may be set with use of the HCI message, together with the setting.

As the predetermined signal to notify the control unit 201, CONNECT_REQ (Bluetooth® Low Energy connection request) conforming to the Bluetooth® Low Energy standard or an advertising packet may be used in place of the scan request. This is because presence of the apparatus conforming to the Bluetooth® Low Energy standard around the image forming apparatus 100 can be known from these signals.

After the setting in step S402 is completed, in step S403, the control unit 201 sets the BLE communication unit 202 to transmit the advertising packet including a head piece (first fragment data) of the plurality of pieces of fragment data generated in step S401. Thereafter, the control unit 201 transitions to a sleep state.

The sleep state is a state waiting for interrupt at power consumption lower than power consumption in the normal state by stopping the instruction execution by the control unit 201 and/or reducing an operation clock frequency from a predetermined frequency (e.g., frequency in normal state). The stopping of instruction execution by the control unit 201 is to stop an instruction fetch by the CPU configuring the control unit 201. In other words, processing in which an instruction code is read from the memory 207 and is transferred to an unillustrated register inside the control unit 201 is not executed. Further, for example, the power supply to the CPU may be stopped to stop instruction execution by the CPU.

After the setting in step S403 is performed, in step S404, the BLE communication unit 202 starts autonomous repetitive transmission operation of the advertising packet. The transmission operation is autonomously started by the BLE communication unit 202 based on the setting in step S403. Alternatively, the control unit 201 may provide a transmission start instruction to the BLE communication unit 202 before the control unit 201 transitions to the sleep state, and the BLE communication unit 202 may start the transmission operation in response to the instruction.

The BLE communication unit 202 first starts transmission of the advertising packet including the first piece of fragment data in the above-described manner.

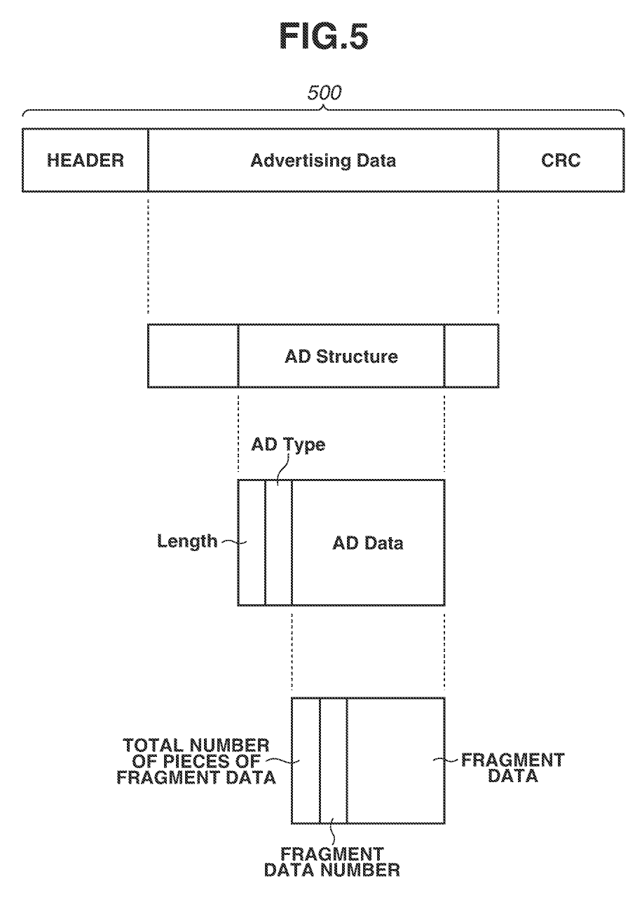

A packet configuration of the advertising packet transmitted by the BLE communication unit 202 is described with reference to FIG. 5. An advertising packet 500 includes a component called AD structure. The AD structure further includes a Length field, an AD Type field, and an AD Data field.

The Length field includes information on a size of the AD structure. The AD Type field includes a value representing that the AD structure includes the fragment data of the information relating to the image forming apparatus 100. The AD Data field includes the information representing the total number of pieces of the fragment data and the information representing the order of the fragment data from the head, together with one of the divided pieces (fragment data) of the information. In this example, the information representing the first piece of fragment data is included because the head fragment data is set. In the following description, the N-th fragment data from the head is referred to as “fragment data N”.

When the repetitive transmission of the advertising packet that includes fragment data 1 in the format of FIG. 5 is started, the image forming apparatus 100 waits for the scan request from the other communication apparatus in step S405. At this time, the control unit 201 transitions to the sleep state and waits for notification of the scan request reception from the BLE communication unit 202.

The scan request reception is notified with LE Scan Request Received Event of the HCI message. The control unit 201 performs setting to itself so as to return from the sleep state when receiving the HCI message, before the control unit 201 transitions to the sleep state. At this time, the control unit 201 can resume the subsequent instruction by the interrupt, by holding the program counter and the contents of the memory. The control unit 201 is configured to generate interrupt when receiving the HCI message from the BLE communication unit 202.

In step S405, the image forming apparatus 100 continues waiting the scan request from the other communication apparatus until receiving the scan request (NO in step S406). At this time, the control unit 201 waits for a notification of the scan request reception from the BLE communication unit 202 in the sleep state.

In a case where the image forming apparatus 100 receives the scan request, and the control unit 201 receives a notification of the scan request reception from the BLE communication unit 202 (YES in step S406), the processing proceeds to step S407. In step S407, the control unit 201 returns from the sleep state to the normal state. In addition, the control unit 201 changes the information (fragment data) to be included in the advertising packet, and sets the BLE communication unit 202 to transmit the advertising packet including the changed information (fragment data).

In this case, the control unit 201 changes the information (fragment data) to be included in the advertising packet in order of fragment data 1, 2, . . . , and N. In a case where the fragment data N has been included in the advertising packet and transmitted, the control unit 201 returns the fragment data to be included in the advertising packet to the fragment data 1.

Alternatively, the control unit 201 may change the fragment data to be included in the advertising packet in order of fragment data N, . . . , 2, and 1. In this case, in a case where the fragment data 1 has been included in the advertising packet and transmitted, the control unit 201 returns the fragment data to be included in the advertising packet to the fragment data N. Moreover, in this case, the fragment data N may be set as the first piece of fragment data set in step S403, in place of the fragment data 1. Further alternatively, the control unit 201 may change the fragment data to be included in the advertising packet and transmitted at random.

After the setting in step S407 is completed, the control unit 201 transitions to the sleep state again. Then, the processing returns to step S404, and the BLE communication unit 202 starts transmission of the advertising packet including the changed fragment data.

The control unit 201 returns from the sleep state every time the control unit 201 receives a notification of the scan request reception, changes the fragment data to be included in the advertising packet, and causes the BLE communication unit 202 to transmit the advertising packet.

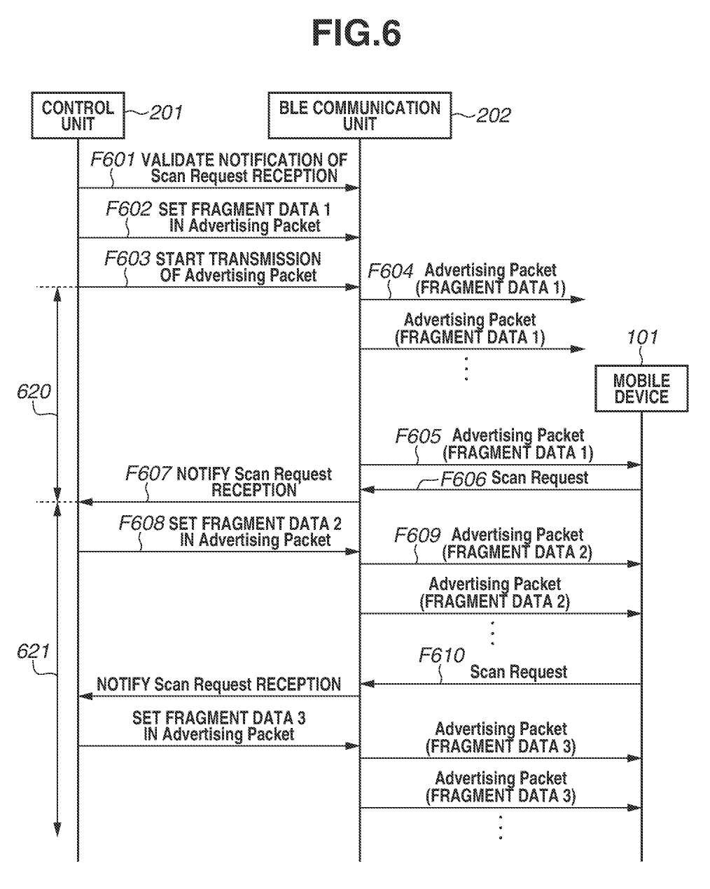

FIG. 6 illustrates a flow of communication inside the image forming apparatus 100 having the above-described configuration and in the communication system. In FIG. 6, only communication relating to the present exemplary embodiment is illustrated. In other words, the communication performed inside the image forming apparatus 100 and in the communication system 10 is not limited to the communication illustrated in FIG. 6.

After the control unit 201 divides the information relating to the image forming apparatus 100 in step S401, the control unit 201 validates the notification of the scan request reception in steps S402 in FIG. 4 and F602 in FIG. 6. Subsequently, the control unit 201 sets the fragment data 1 as the information to be included in the advertising packet in steps S403 in FIG. 4 and F602 in FIG. 6, and causes the BLE communication unit 202 to start transmission of the advertising packet including the information on the fragment data 1 in steps S404 in FIG. 4 and F603 in FIG. 6. Further, in step F604 in FIG. 6, the BLE communication unit 202 starts repetitive transmission of the advertising packet including the fragment data 1.

In the meantime, in step S405, the image forming apparatus 100 waits for the scan request from the mobile device 101. More specifically, the control unit 201 transitions to the sleep state and waits for the notification of the scan request reception from the BLE communication unit 202, and the BLE communication unit 202 waits for the scan request from the mobile device 101.

Thereafter, the mobile device 101 moved to the vicinity of the image forming apparatus 100 receives the above-described advertising packet in step F605 in FIG. 6, and transmits the scan request in step F606 in FIG. 6. The BLE communication unit 202 that has received the scan request issues a notification of the scan request reception to the control unit 201 in steps S405 in FIG. 4 and F607 in FIG. 6. When receiving the notification of the scan request reception, the control unit 201 returns from the sleep state, sets the fragment data 2 as the information to be included in the advertising packet, and transitions to the sleep state again. The processing corresponds to steps S405, “YES in step S406”, S407, S404 in FIG. 4, and F608 in FIG. 6.

Thereafter, in step F609 in FIG. 6, the BLE communication unit 202 starts transmission of the advertising packet including the information on the fragment data 2. When the mobile device 101 issues the scan request to the advertising packet including the information on the fragment data 2 in step F610, the fragment data 3 is set in the advertising packet through the processing flow similar to the above-described processing flow. Thereafter, all of the pieces of fragment data are transmitted through the similar processing. Since each of the pieces of fragment data includes the information to connect the fragment data, the mobile device 101 that has received all of the pieces of fragment data can restore the information, before division, relating to the image forming apparatus 100.

During a period 620 in FIG. 6, the control unit 201 performs the processing in step S404 in FIG. 4 and maintains the sleep state. In other words, the control unit 201 maintains the sleep state while the mobile device 101 to receive the advertising packet of the image forming apparatus 100 is not present around the image forming apparatus 100. On the other hand, during a period 621 in which the mobile device 101 is present around the image forming apparatus 100, the processing in which the fragment data to be included in the advertising packet is sequentially changed and all of the pieces of fragment data are transmitted, is performed. Accordingly, it is possible to efficiently divide and transmit large data with use of the advertising packet while suppressing power consumption during the period during which the device is not present around the image forming apparatus 100.

Immediately before the control unit 201 transitions to the sleep state in step S404, the control unit 201 may perform control to stop the LAN communication unit 203, the print unit 204, and the UI unit 205. In this case, the stopped units are also started up when the control unit 201 is started up in response to the notification of the scan request reception thereafter. The stoppage indicates turning off or transition to the sleep state. This makes it possible to further reduce the power consumption during the period during which the mobile device 101 is not present around the image forming apparatus 100.

Next, a second exemplary embodiment is described. In the first exemplary embodiment, the fragment data to be included in the advertising packet is changed every time the predetermined signal (e.g., scan request) conforming to the Bluetooth® Low Energy standard is received from the other communication apparatus. In the second exemplary embodiment, when a predetermined signal conforming to the Bluetooth® Low Energy standard is once received from the other control apparatus, the fragment data to be included in the advertising packet is changed every predetermined time.

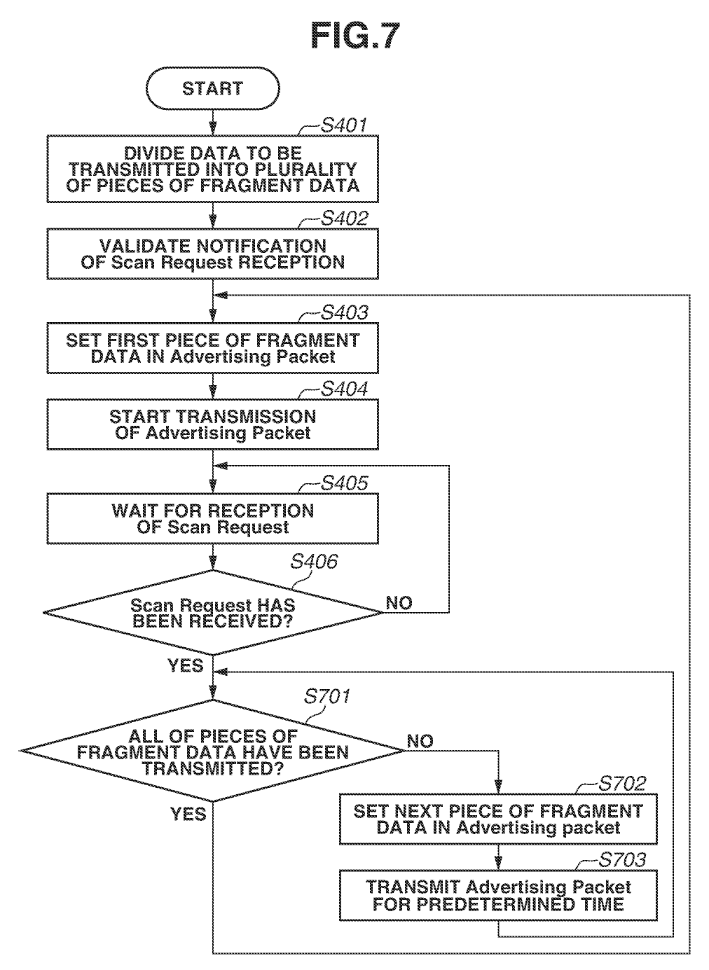

In the second exemplary embodiment, the control unit 201 performs processing of a flowchart illustrated in FIG. 7 in place of the processing of the flowchart illustrated in FIG. 4. The processing of the flowchart illustrated in FIG. 7 is started together with the start of the processing in the flowchart illustrated in FIG. 3, and is executed in parallel with the processing in steps S301 and S302. Further, the processing in the flowchart illustrated in FIG. 7 is interrupted while the processing in steps S301 and S302 is not executed. Further, the control unit 201 resumes the processing in the flowchart illustrated in FIG. 7 from the interrupted step at a timing when the processing in steps S301 and S302 is resumed. Further, when the processing in the flowchart illustrated in FIG. 3 ends, the processing in the flowchart illustrated in FIG. 7 also ends.

Hereinbelow, description is given along the flowchart illustrated in FIG. 7. The same numerals are assigned to the processes similar to the processes in FIG. 4, and description thereof is omitted. More specifically, the processes in steps S401 to S406 are similar to the processes in FIG. 4, and description thereof is omitted. In this example, a case where the image forming apparatus 100 receives the scan request in step S406 (YES in step S406) is described.

In step S406, when the image forming apparatus 100 receives the scan request (YES in step S406), the control unit 201 returns from the sleep state to the normal state, and the processing proceeds to step S701. In step S701, the control unit 201 determines whether all of the pieces of fragment data have been included in the advertising packet and transmitted. For example, in a case where the information on the image forming apparatus 100 is divided into three pieces of fragment data in step S401, the control unit 201 determines whether each of the fragment data 1, 2, and 3 has been included in the advertising packet and transmitted.

In a case where not all of the pieces of fragment data have been included in the advertising packet and transmitted (NO in step S701), the processing proceeds to step S701. In step S701, the control unit 201 changes the information (fragment data) to be included in the advertising packet. As a result, the BLE communication unit 202 transmits the advertising packet including the changed information (fragment data). Further, in step S703, the BLE communication unit 202 repeatedly transmits the advertising packet including the changed information (fragment data) for a predetermined time. The predetermined time is longer than a transmission period of the advertising packet. When the predetermined time elapses, the processing returns to step S701. The control unit 201 may transition to the sleep state while the processing in step S703 is executed. In a case where the control unit 201 has transitioned to the sleep mode, the control unit 201 returns from the sleep state when the processing proceeds from step S703 to step S701.

Thereafter, the processing in steps S701 to S703 performed by the control unit 201 and the BLE communication unit 202 is repeated until all of the pieces of fragment data have been included in the advertising packet and transmitted. When all of the pieces of fragment data have been included in the advertising packet and transmitted (YES in step S701), the processing returns to step S403.

When receiving the predetermined signal conforming to the Bluetooth® Low Energy standard once from the other communication apparatus, the image forming apparatus 100 changes the fragment data to be included in the advertising packet every predetermined time until all of the pieces of fragment data have been transmitted, in the above-described manner. In place of the condition that all of the pieces of fragment data have been transmitted, the fragment data to be included in the advertising packet may be changed every predetermined time while another predetermined condition is satisfied, in the case where the predetermined signal conforming to the Bluetooth® Low Energy standard is once received. Examples of the predetermined condition include a predetermined period and a condition that a predetermined number of pieces of fragment data have been transmitted.

Through the above-described control, it is possible to transmit all of the pieces of fragment data using a first scan request as a trigger even in a case where the mobile device 101 does not transmits the scan request to the same Bluetooth® Low Energy device multiple times. Further, the processing to change the information to be included in the advertising packet is not executed until the first scan request is received. Accordingly, it is possible to efficiently divide and transmit large data with use of the advertising packet while suppressing the power consumption during the period in which the device is not present around the image forming apparatus 100, as with the first exemplary embodiment.

The above-described first and second exemplary embodiments may be appropriately combined. For example, when the predetermined signal (e.g., scan request) is received, the processing to change the fragment data to be included in the advertising packet is started every predetermined time. Then, in a case where the scan request is received from the other communication apparatus within the predetermined time, the processing to change the fragment data to be included in the advertising packet may be performed before the predetermined time elapses. Such a configuration also provides the similar effects.

In addition, in any of the above-described exemplary embodiments, at least a part of the processing in the flowcharts illustrated in FIG. 3, FIG. 4, and FIG. 7 may be achieved by hardware. In a case where the processing is achieved by hardware, for example, a predetermined complier may be used to automatically generate a dedicated circuit on a field programmable gate array (FPGA) from the program for achieving each of the steps. Further, a gate array circuit may be configured and achieved as hardware, in a manner similar to the FPGA.

The present disclosure is achievable through processing in which a program for achieving one or more functions of the above-described exemplary embodiments is supplied to a system or an apparatus through a network or a storage medium, and one or more processors in a computer of the system or the apparatus read and execute the program. The present disclosure is achievable by an ASIC for achieving one or more functions.

According to the present disclosure, information to be included in the advertising packet by taking the surrounding situation into consideration can be efficiently changed.

### Other Embodiments

Embodiment(s) of the can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-066931, filed Mar. 30, 2018, which is hereby incorporated by reference herein in its entirety.

What is claimed is:

1. A communication apparatus, comprising:
a transmission unit configured to transmit an advertising packet conforming to Bluetooth® Low Energy standard;
a reception unit configured to receive a predetermined signal conforming to the Bluetooth® Low Energy standard from another communication apparatus; and
a control unit configured to, based on receipt of the predetermined signal, control the transmission unit to transmit the advertising packet including information different from information before the predetermined signal is received.

2. The communication apparatus according to claim 1, wherein the predetermined signal is a scan request conforming to the Bluetooth® Low Energy standard.

3. The communication apparatus according to claim 2, wherein in a case where the reception unit receives the scan request, the reception unit notifies the control unit of an LE Scan Request Received Event of a host controller interface (HCI) message conforming to the Bluetooth® Low Energy standard.

4. The communication apparatus according to claim 1, wherein the control unit sets information to be included in the advertising packet in the transmission unit to change the information to be included in the advertising packet.

5. The communication apparatus according to claim 4, wherein the control unit transitions to a sleep state based on setting of the information to be included in the advertising packet in the transmission unit.

6. The communication apparatus according to claim 5, wherein in a case where the reception unit receives the predetermined signal while the control unit is in the sleep state, the control unit releases the sleep state in response to receipt of the predetermined signal.

7. The communication apparatus according to claim 5, wherein the sleep state is a state where execution of instructions by the control unit is stopped, or a state where an operation clock frequency of the control unit is made lower than a predetermined frequency.

8. The communication apparatus according to claim 5, further comprising a user interface configured to receive a user operation,
wherein the control unit performs control to reduce power consumption by the user interface before the control unit transitions to the sleep state.

9. The communication apparatus according to claim 1, further comprising a dividing unit configured to divide predetermined information to be provided to the other communication apparatus into first information and second information,
wherein in a case where the predetermined signal is received by the reception unit while the transmission unit transmits the advertising packet including the first information, the control unit controls, based on receipt of the predetermined signal, the transmission unit to transmit the advertising packet including the second information.

10. The communication apparatus according to claim 1, wherein the control unit changes the information to be included in the advertising packet every time a predetermined time elapses while a predetermined condition is satisfied after the predetermined signal is received.

11. The communication apparatus according to claim 1, wherein the advertising packet includes one or more of identification information on the communication apparatus, information relating to a service provided by the communication apparatus, or information on a wireless network to connect with the communication apparatus.

12. The communication apparatus according to claim 1,
wherein the communication apparatus is an image forming apparatus, and
wherein the advertising packet includes at least information relating to a remaining amount of sheets, ink, or toner held by the image forming apparatus, or information relating to a number of print jobs.

13. A method for controlling a communication apparatus, the method comprising:
transmitting an advertising packet conforming to Bluetooth® Low Energy standard;
receiving a predetermined signal conforming to the Bluetooth® Low Energy standard from another communication apparatus; and
transmitting, based on receipt of the predetermined signal, the advertising packet that includes information different from information before the predetermined signal is received.

14. A non-transitory computer-readable storage medium storing a program for causing a computer to execute a method, the method comprising:
transmitting an advertising packet conforming to Bluetooth® Low Energy standard;
receiving a predetermined signal conforming to the Bluetooth® Low Energy standard from another communication apparatus; and
transmitting, based on receipt of the predetermined signal, the advertising packet that includes information different from information before the predetermined signal is received.
